(19) United States
(12) Patent Application Publication
(10) Pub. No.: US 2010/0253773 A1
(43) Pub. Date: Oct. 7, 2010

(54) INTRA-ORAL MEASUREMENT DEVICE AND INTRA-ORAL MEASUREMENT SYSTEM

(76) Inventors: Sadafumi Oota, Osaka (JP); Seiji Hamano, Hyogo (JP); Fumio Sugata, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/675,183

(22) PCT Filed: Apr. 7, 2009
(86) PCT No.: PCT/JP2009/001603

§ 371 Date: Feb. 25, 2010

(30) Foreign Application Priority Data
May 13, 2008 (JP) 2008-125537

(51) Int. Cl. H04N 7/18; G01N 21/55

(52) U.S. Cl. 348/77; 356/445; 348/E07.085

(57) ABSTRACT

An intra-oral measurement device according to the present invention is provided with a light projecting unit for irradiating lights in at least two different wavelengths along an identical light axis toward an object to be measured that includes at least a tooth in an oral cavity, and an image pickup unit for receiving lights reflected on the object to be measured and picking up an image, so that an intra-oral shape can be accurately measured without spraying the metal powder within the oral cavity.

### TECHNICAL FIELD

The present invention relates to an intra-oral measurement device and an intra-oral measurement system capable of directly measuring an inside of an oral cavity.

### RELATED ART

Conventionally, a manufacturing method by casting metal material or ceramic material using a lost-wax casting method has commonly been employed as manufacturing methods of dental prostheses such as an inlay, a crown, and a bridge.

However, in recent years, as the methods of manufacturing dental prostheses that are alternative to the lost-wax casting process, such methods of designing and manufacturing dental prosthesis using a CAD/CAM system after measuring teeth and gingivae in the oral cavity using an optical three-dimensional camera, as typified by a cerec system, have been attracting attention.

According to such methods, a shape of such as an abutment tooth, a tooth having a cavity, adjacent dentition, and dental antagonist is scanned directly in the oral cavity using an optical three-dimensional camera, thereby carrying out an intra-oral measurement of the teeth and gingivae. As the optical three-dimensional camera, a camera carrying out a non-contact three-dimensional measurement, as typified by a phase shift method and a space encoding method, is used. As this type of the optical three-dimensional camera, for example, a camera described in patent document 1 (Japanese Unexamined Patent Application Publication No. 2000-74635) is known.

FIG. 15 is an illustrative view showing a configuration of a conventional optical three-dimensional camera.

Referring to FIG. 15, the conventional optical three-dimensional camera is provided with, within an external casing 101, a light source 102, a pattern mask 103, apertures 104, 105, a prism 106, and an imaging sensor 107 such as a CCD.

Light emitted from the light source 102 passes through the pattern mask 103 to form light in stripe pattern. The light in stripe pattern is, after passing through the aperture 104 to be subject to a fine control of its light axis, refracted by the prism 106 and projected onto an object to be measured 108. The light in stripe pattern projected onto the object to be measured 108 is reflected on a surface of the object to be measured 108 to enter to the prism 106, and refracted by the prism 106. The refracted light then passes through the aperture 105 and received by the imaging sensor 107 such as a CCD.

By converting data of a two-dimensional still image received (picked up) by the imaging sensor 107 into data of three-dimensional coordinates using a triangulation method, it is possible to obtain three-dimensional image data of the object to be measured 108 for designing and producing dental prosthesis using a CAD/CAM system.

By using the conventional optical three-dimensional camera and the CAD/CAM system, it is possible to efficiently manufacture the dental prosthesis, as compared to the lost-wax casting process, and it is possible to manufacture a dental prostheses that is highly fit to the oral cavity.

However, in such a manufacturing method using the optical three-dimensional camera and the CAD/CAM system, while a computer can automatically perform calculation in order to convert the shape of the measured tooth into information for processing, it is difficult to accurately measure the shapes of the teeth and the gingivae. This is because it is not possible to capture a clear image since an intra-oral shape is different from patient to patient, and since a surface reflectivity of each organ varies due to differences in a condition of the carious tooth, and compositions of enamel, dentin, and gingiva that constitute the teeth. Therefore, according to the manufacturing method described above, it is difficult to manufacture an ideal dental prosthesis that is highly fit to the oral cavity.

In order to address to the issue noted above, in the cerec system, a metal powder such as titanium oxide is sprayed within an oral cavity, thereby uniformizing the differences (variations) of the surface reflectivities within the oral cavity.

Characteristics of the surface reflectivities of the teeth and the gingivae are described in non-patent document 1 (Leo J. Miserendino, Robert M. Pick, Tadamasa Tsuda, “Lasers in Dentistry”, first edition, Quintessence Publishing Co., Inc., Oct., 10, 2004), and in non-patent document 2 (Tomotaka Takeda, “Chromatic Study on Gingiva Using Spectroradiometry: Concerning the Anterior Teeth of Young People”, The journal of the Japan Prosthodontic Society, Japan Prosthodontic Society, Apr., 1, 1987, vol. 31, No. 2, pp. 363-370).

Non-patent document 1 describes that a peak surface reflectivity of enamel is in the vicinity of 550 nm, and a peak surface reflectivity of dentin is in the vicinity of 700 nm. Further, non-patent document 2 describes that a peak surface reflectivity of gingivae is in the vicinity of 650 nm.

### SUMMARY OF THE INVENTION

However, spraying of the metal powder as described in the patent document 1 is a treatment that gives bitter tastes or uncomfortable feelings to patients, and a treatment that requires time and skillfulness for dental surgeons as it is necessary to spray the metal powder uniformly in the oral cavity.

Thus, an object of the present invention is to solve the issue noted above, and to provide an intra-oral measurement device capable of accurately measuring an intra-oral shape without spraying a metal powder within an oral cavity.

In order to realize the above object, the present invention is configured as described below.

According to a first aspect of the present invention, there is provided an intra-oral measurement device comprising:

a light projecting unit for irradiating lights in at least two different wavelengths along an identical light axis toward an object to be measured that includes at least a tooth in an oral cavity; and

an image pickup unit for receiving lights reflected on the object to be measured and picking up an image.

According to a second aspect of the present invention, there is provided the intra-oral measurement device as defined in first aspect, wherein the light projecting unit is provided with LED light sources of the at least two different wavelengths.

According to a third aspect of the present invention, there is provided the intra-oral measurement device as defined in first aspect, wherein the light projecting unit is provided with a white light source, and wavelength filters of the at least two different wavelengths movable on a light axis of the white light source.

According to a fourth aspect of the present invention, there is provided the intra-oral measurement device as defined in first aspect, wherein the light projecting unit irradiates lights in a coded stripe pattern.

According to a fifth aspect of the present invention, there is provided the intra-oral measurement device as defined in first aspect, wherein the lights in different wavelengths include a light in a wavelength of 500 to 565 nm and a light in a wavelength of 625 to 740 nm.

According to a sixth aspect of the present invention, there is provided the intra-oral measurement device as defined in first aspect, further comprising: an image processing unit for synthesizing a plurality of images based on the lights in the different wavelengths picked up by the image pickup unit into a single image, and converting the synthesized image into three-dimensional coordinates, thereby obtaining a three-dimensional image of the object to be measured.

According to a seventh aspect of the present invention, there is provided the intra-oral measurement device as defined in sixth aspect, wherein the image processing unit synthesizes the plurality of images based on the lights in the different wavelengths according to luminance information of each pixel in the images.

According to an eighth aspect of the present invention, there is provided an intra-oral measurement system, comprising:

a light projecting unit for irradiating lights in at least two different wavelengths along an identical light axis toward an object to be measured that includes at least a tooth in an oral cavity;

an image pickup unit for receiving lights reflected on the object to be measured and picking up an image; and

an image processing unit for synthesizing a plurality of images picked up in the different wavelengths by the image pickup unit into a single image, and converting the synthesized image into three-dimensional coordinates, thereby obtaining a three-dimensional image of the object to be measured.

According to the intra-oral measurement device and the intra-oral measurement system of the present invention having the above configurations, it is possible to accurately measure the intra-oral shape without spraying the metal powder within the oral cavity.

### BRIEF DESCRIPTION OF DRAWINGS

These and other aspects and features of the present invention will become clear from the following description taken in conjunction with the preferred embodiments thereof with reference to the accompanying drawings, in which:

FIG. 1 is an illustrative view showing a schematic configuration of an intra-oral measurement system having an oral scanner according to a first embodiment of the present invention;

FIG. 2 is a view showing the oral scanner of FIG. 1 seen from downside;

FIG. 3 is a schematic perspective view showing how a surface shape of a back tooth of a patient is measured using the oral scanner of FIG. 1;

FIG. 4 is a schematic perspective view showing how a surface shape of a front tooth of the patient is measured using the oral scanner of FIG. 1;

FIG. 5 is a block diagram of the intra-oral measurement system according to the first embodiment of the present invention;

FIG. 6 is an illustrative view showing a schematic configuration of a light projecting unit of the intra-oral measurement system of FIG. 1;

FIG. 7 is a flowchart of measuring a shape of an object to be measured using the intra-oral measurement system according to the first embodiment of the present invention;

FIG. 8 is a diagram showing examples of a gray pattern as light in stripe pattern that is projected to the object to be measured;

FIG. 9 is a flowchart of taking an image of the object to be measured in the intra-oral measurement system according to the first embodiment of the present invention;

FIG. 10 is a flowchart of image synthesis processing in the intra-oral measurement system according to the first embodiment of the present invention;

FIG. 11A is a diagram showing a G signal image picked up in the intra-oral measurement system according to the first embodiment of the present invention;

FIG. 11B is a histogram of luminance values for pixels in the G signal image of FIG. 11A;

FIG. 11C is a graphical chart showing a smooth line connecting the histogram of FIG. 11B using a least-square technique;

FIG. 12 is an illustrative view showing a schematic configuration of an oral scanner containing an image processing unit;

FIG. 13 is a flowchart of image synthesis processing in an intra-oral measurement system according to a second embodiment of the present invention;

FIG. 14 is an illustrative view showing a schematic configuration of a light projecting unit of an intra-oral measurement system according to a third embodiment of the present invention; and

FIG. 15 is a conceptual diagram showing a measurement of a tooth and a gingiva according to patent document 1.

### DESCRIPTION OF THE PREFERRED EMBODIMENTS

In the following description of the present invention, the like components shown in the accompanying drawings are indicated by the like numerals and an explanation is not given here.

The following describes embodiments of the present invention with reference to the drawings.

### First Embodiment

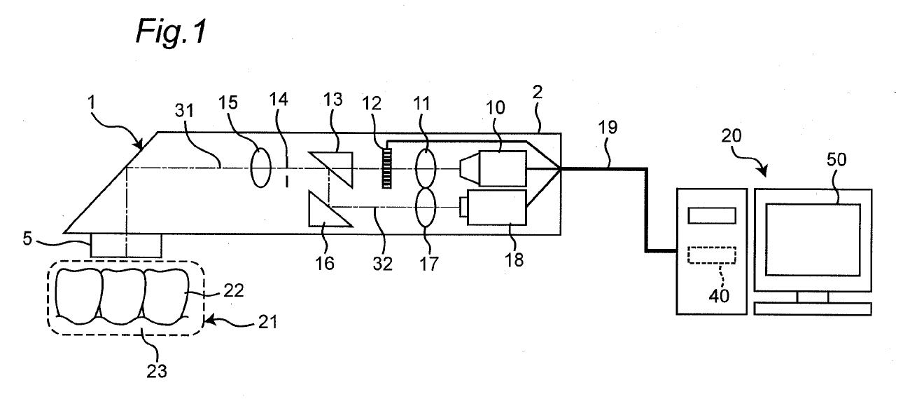

FIG. 1 is an illustrative view showing a schematic configuration of an intra-oral measurement system having an intra-oral measurement device (hereinafter referred to as the oral scanner) according to a first embodiment of the present invention.

Referring to FIG. 1, an oral scanner 1 is configured to have a size with which the oral scanner 1 can be directly inserted into an oral cavity of a patient and is provided with an external casing 2 configured by material that has no affect on a human body.

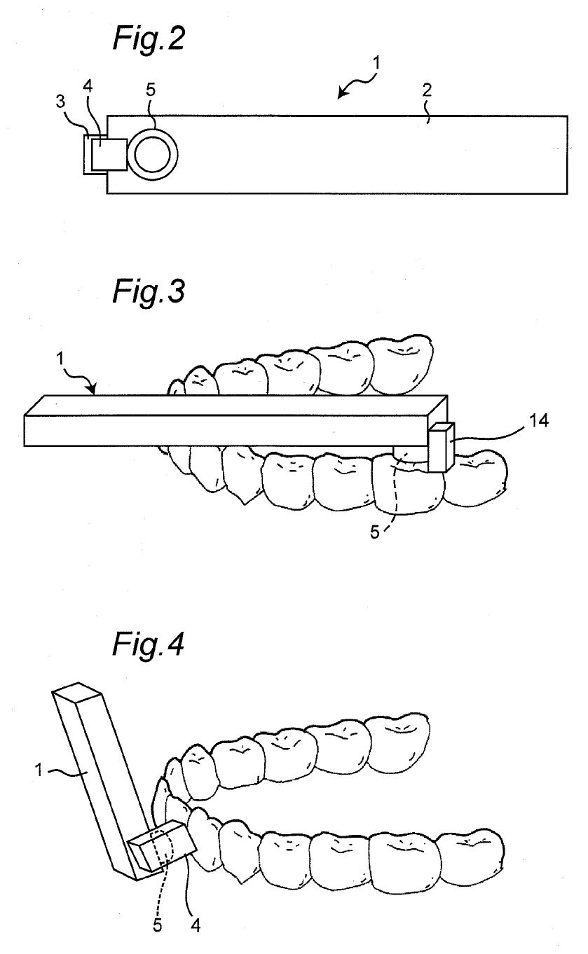

At a tip end of the external casing 2, a rubber attachment portion 3 is provided, and the rubber attachment portion 3 is removably provided with a rubber 4 as one example of a gap retaining member. The rubber 4 is, as shown in FIG. 2, provided adjacent to an irradiation port 5 provided on a side of the tip end of the external casing 2. The rubber 4 is a disposable member used for maintaining a gap between the irradiation port 5 and an object to be measured 21 to be a constant distance L (5 mm, for example), and is configured by a material having no problem from a hygiene standpoint. Further, the rubber 4 has a predetermined hardness so that the gap between the irradiation port 5 and the object to be measured 21 can be maintained constant, and a tip end of the rubber 4 is soft so as to be deformable in accordance with a shape of a portion within the oral cavity with which the tip end is brought into contact. For example, the rubber 4 is configured by a rubber having a dual structure in which a quality of the material is different between a main body and the tip end.

When measuring a surface shape of a back tooth of the patient using the oral scanner 1, as shown in FIG. 3, the oral scanner 1 can be positioned so that the rubber 4 is brought into contact with a portion adjacent to the object to be measured 21 (a tooth next to a tooth to be measured, for example).

It is noted that an attachment position and a number of the rubber 4 are not particularly limited, and can be set according to the object to be measured 21. For example, when measuring a surface shape of a front tooth of the patient using the oral scanner 1, as shown in FIG. 4, it is preferable to attach the rubber 4 on a side surface of the oral scanner 1, instead of the side of the tip end. Note that, in FIG. 3 and FIG. 4, the configuration of the oral scanner 1 is shown in a simplified manner.

Within the external casing 2, a light projecting unit 10, a collecting lens 11, a pattern mask 12 configured by such as an LC shutter (liquid crystal shutter), a beam splitter 13, an aperture 14, and an objective collecting lens 15 are disposed along an identical axis, and in parallel to this axis, a mirror 16, an imaging lens 17, an imaging sensor 18 such as a CCD are disposed along an identical axis. Furthermore, the oral scanner 1 is connected to an external device 20 such as a PC (personal computer) via a transfer cable 19.

Lights irradiated from the light projecting unit 10 are collected through the collecting lens 11, and converted into light in stripe pattern by the pattern mask 12. The converted light in stripe pattern enters the beam splitter 13, and is split, by the beam splitter 13, between a projected light path 31 toward the object to be measured 21 and an observation light path 32 toward the imaging sensor 18 side. The light in stripe pattern directed to the projected light path 31 passes through the aperture 14 and the objective collecting lens 15, and is projected onto the object to be measured 21. The light in stripe pattern projected onto the object to be measured 21 is reflected on the object to be measured 21 and passes through the objective collecting lens 15, the aperture 14, the beam splitter 13, the mirror 16, and the imaging lens 17 in the stated order, and received and imaged by the imaging sensor 18. Data of a two-dimensional image picked up by the imaging sensor 18 is transferred to an image processing unit 40 via the transfer cable 19.

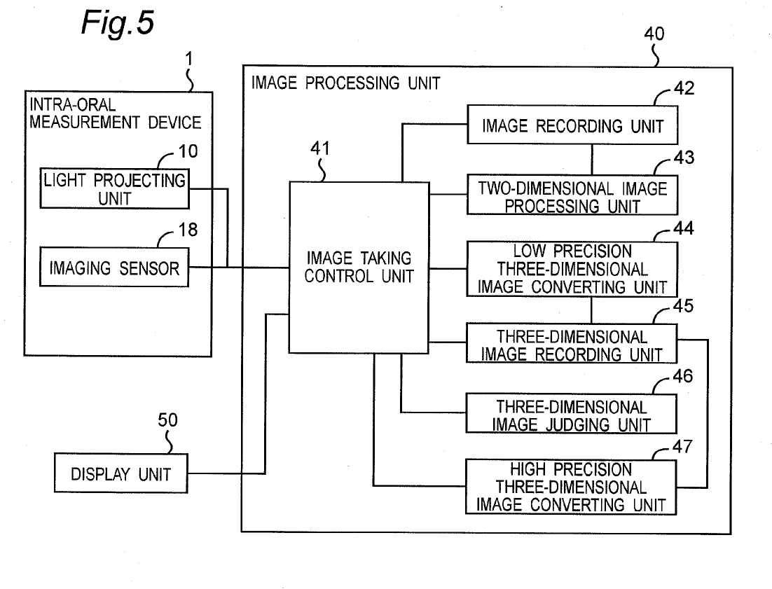

The image processing unit 40 is stored in a CPU (central processing unit, not shown in the drawing) of the external device 20. The image processing unit 40 converts the transferred data of the two-dimensional image into data of three-dimensional coordinates, and obtains three-dimensional image data of the object to be measured 21 for designing and producing a dental prosthesis. The image processing unit 40 is, as shown in FIG. 5, provided with an image taking control unit 41, an image recording unit 42, a two-dimensional image processing unit 43, a low precision three-dimensional image converting unit 44, a three-dimensional image recording unit 45, a three-dimensional image judging unit 46, and a high precision three-dimensional image converting unit 47. Functions of the components of the image processing unit 40 will be later described in detail.

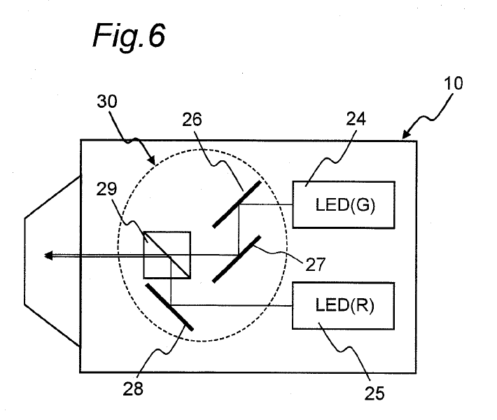

Next, referring to FIG. 6, a configuration of the light projecting unit 10 is described. FIG. 6 is an illustrative view showing the schematic configuration of the light projecting unit of the intra-oral measurement system according to the first embodiment of the present invention.

The light projecting unit 10 is a light source for clearly taking an image of the object to be measured 21 including at least a tooth 22 within the oral cavity of the patient. Referring to FIG. 6, the light projecting unit 10 is provided with an LED light source 24 as one example of a first light source that irradiates light in a wavelength of 500 to 565 nm (green), an LED light source 25 as one example of a second light source that irradiates light in a wavelength of 625 to 740 nm (red), and a mirror group 30 configured by mirrors 26-28 and a beam splitter 29.

The light from the two LED light sources 24, 25 is irradiated after adjusted through the mirror group 30 such that respective light axes match with each other, that is, adjusted to have an identical light axis.

TABLE 1

Wavelength of Projected Light

| | 500 to 565 nm | 625 to 740 nm |
|---|---|---|
| Enamel | ◯ | X |
| Dentin | Δ | ◯ |
| Gingiva | X | ◯ |

The table 1 shows tabulated results of visual conditions of the tooth 22 and a gingiva 23 in the oral cavity in the corresponding wavelength of the projected light, based on various experimentation and documents. In the table 1, a circular mark represents a case in which a clear image has been obtained, a triangular mark represents a case in which an identifiable image has been obtained although partially unclear, and an x mark represents a case in which an identifiable image has not been obtained.

As shown in the table 1, as the enamel has a higher surface reflectivity to the light in the wavelength of 500 to 565 nm, it is possible to obtain a clear image of the enamel by irradiating the light in this wavelength. As the dentin and the gingiva has a higher surface reflectivity to the light in the wavelength of 625 to 740 nm, it is possible to obtain a clear image of the dentin and the gingiva by irradiating the light in this wavelength. Therefore, the intra-oral measurement system according to the first embodiment is configured to use the two LED light source 24, 25 respectively irradiating the light in two different wavelengths, thereby obtaining the clear images for all of the enamel, the dentin, and the gingiva.

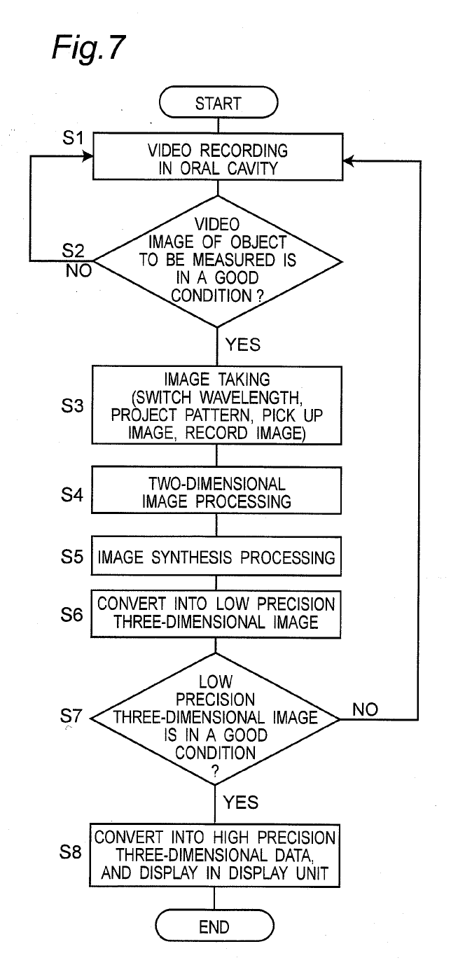

Next, referring to FIG. 1, FIG. 5, and FIG. 7, a measurement method of the object to be measured by the intra-oral measurement system according to the first embodiment is described. FIG. 7 is a flowchart of measuring the inside of the oral cavity using the intra-oral measurement system according to the first embodiment.

First, the oral scanner 1 is set within the oral cavity of the patient, and the video recording by the oral scanner 1 in the oral cavity starts such as by, for example, a dentist pressing a button for starting video recording (not shown in the drawing) of the external device 20, (Step S1).

At this time, the distance L between the object to be measured 21 and the irradiation port 5 is maintained constant (5 mm, for example) by the rubber 4. The video recording by the oral scanner 1 is carried out, under the control of the image taking control unit 41, by irradiating the light from the light projecting unit 10, and receiving the light reflected on the object to be measured 21 and taking an video image by the imaging sensor 18. The video image taken by the oral scanner 1 is transferred to the image taking control unit 41 via the transfer cable 19, and displayed in a display unit 50 of the external device 20 under the control of the image taking control unit 41. Here, the oral scanner 1 carries out the same operation as common video cameras.

Then, the oral scanner 1 is moved so that the object to be measured 21 is correctly displayed in the display unit 50, and it is confirmed whether or not a video image of the displayed object to be measured 21 is in a good condition (Step S2). At this time, it is possible to adjust an imaging position of the oral scanner 1 more correctly with the object to be measured 21 by, for example, pointing a frame for selecting a display range or a mark such as a cross displayed in the display unit 50 over the object to be measured 21.

Whether the video image of the object to be measured 21 is in a good condition or not is judged by whether or not an average gray level of the object to be measured 21 (the gingiva 23, for example) is no smaller than 40 gray levels when an LED light source with an output of 3 W is used as the light projecting unit 10 and luminance values are expressed in 256 gray levels, for example. In other words, it is judged to be in a good condition when the average gray level is not smaller than 40 gray levels, and it is judged to be not in a good condition when the average gray level is smaller than 40 gray levels. It is noted that this judgment can be made by the dentist, or can be automatically made by the image processing unit 40.

If the video image of the object to be measured 21 is not in a good condition, various setting and a measuring position are adjusted so that the video image of the object to be measured 21 is in a good condition. If the video image of the object to be measured 21 is in a good condition, an image of the object to be measured 21 is picked up (Step S3). It is preferable that the picking up is carried out by, for example, the dentist stepping on a foot operated switch provided for a treatment table.

Next, in order to obtain the three-dimensional coordinates of the object to be measured 21 according to, for example, a space encoding method or a phase shift method, the light in stripe pattern is irradiated toward the object to be measured 21 and the image of the object to be measured 21 is picked up under the control of the image taking control unit 41. With this, an image (two-dimensional still image) data piece of the object to be measured 21 is obtained.

Subsequently, after changing the wavelength of the lights irradiated from the light projecting unit 10 (for example, switching the light source of the light projecting unit 10 from the LED light source 24 to the LED light source 25), the image of the object to be measured 21 is picked up. Then, the light in stripe pattern is irradiated toward the object to be measured and the image of the object to be measured 21 is picked up under the control of the image taking control unit 41. With this, an image (two-dimensional still image) data piece of the object to be measured 21 is obtained.

The picked up image (two-dimensional still image) data pieces are recorded in the image recording unit 42 in order to convert into three-dimensional images using the triangulation method. Note that the image taking method of the object to be measured 21 using the light in different wavelengths will be described later in detail.

Next, the plurality of obtained image data pieces of the object to be measured 21 are synthesized in the following manner.

First, in order to improve contrast in stripe pattern of the image data pieces recorded in the image recording unit 42, the two-dimensional image processing unit 43 performs two-dimensional image processing such as noise removal, gray level correction, and gamma correction to the image data pieces (Step S4).

Then, based on a luminance value of each pixel in the image data pieces, the two-dimensional image processing unit 43 divides the pixels of the image data pieces into a pixel group corresponding to a region for the tooth 22 and a pixel group corresponding to a region for the gingiva 23. Here, as described above, the tooth (enamel) 22 is clearly shown in the image that has been picked up using the LED light source 24, and the gingiva 23 is clearly shown in the image that has been picked up using the LED light source 25. Therefore, the two-dimensional image processing unit 43 synthesizes data for the pixel group corresponding to the region for the tooth 22 out of the image that has been picked up using the LED light source 24, and data for the pixel group corresponding to the region for the gingiva 23 out of the image that has been picked up using the LED light source 25 (Step S5). At this time, the gray level correction of the pixel group that is converted into the three-dimensional coordinates can be performed by referring to a histogram of the luminance values of the pixels. The method of image synthesizing processing to the region of the tooth 22 and the region of the gingiva 23 will be described later in detail.

Next, the low precision three-dimensional image converting unit 44 reduces a data amount of the synthesized image data piece, and converts the data piece whose amount has been reduced, for example, to 10% to 50% into the three-dimensional coordinates using the triangulation method. With this, a three-dimensional image in low precision is obtained (Step S6). The low precision three-dimensional image is recorded in the three-dimensional image recording unit 45.

Thereafter, the three-dimensional image judging unit 46 judges whether or not the low precision three-dimensional image is in a good condition (Step S7).

If the three-dimensional image judging unit 46 judges that the low precision three-dimensional image is not in a good condition, the process returns to Step S1.

On the other hand, if the three-dimensional image judging unit 46 judges that the low precision three-dimensional image is in a good condition, the high precision three-dimensional image converting unit 47 converts the entire synthesized image data piece into the three-dimensional coordinates using the triangulation method. The obtained three-dimensional coordinates are recorded in the three-dimensional image recording unit 45 as such as point group data or STL (Stereo Lithography) data, for example, and displayed in the display unit 50 (Step S8). By performing synthesizing processing to the point group data or the STL data, a three-dimensional image in high precision is obtained.

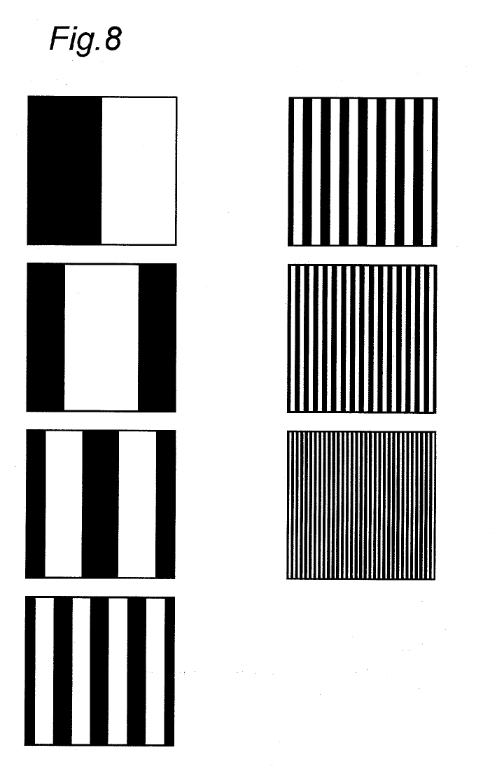

It is noted that, as described above, it is preferable to use the space encoding method or the phase shift method for the measurement of the three-dimensional coordinates of the object to be measured 21. With this, accuracy in the measurement can be improved. Note that, when using the space encoding method, it is preferable to use a pattern called Gray code (hereinafter referred to as a gray pattern) as shown in FIG. 8 as the light in stripe pattern projected onto the object to be measured 21. FIG. 8 shows seven examples of the gray pattern. Further, when using the phase shift method, it is preferable to use a known grayscale pattern that changes sinusoidally as the light in stripe pattern projected onto the object to be measured 21. Note that, when a high measurement accuracy is not required, a normal code pattern can be used as the light in stripe pattern projected onto the object to be measured 21.

Moreover, Step S5, S6 as described above are carried out in a case in which the obtained three-dimensional image is different from the surface shape of the object to be measured 21 due to faulty imaging, and time until the three-dimensional image is obtained is wasted, and are not necessarily required.

Furthermore, the judgment of whether or not the low precision three-dimensional image is in a good condition in Step S6 as described above can be carried out by the dentist by displaying the low precision three-dimensional image in the display unit 50. Specifically, in this case, the dentist compares a shape of the object to be measured 21 that the dentist sees with the shape of the object to be measured 21 in the low precision three-dimensional image, and judges whether or not the low precision three-dimensional image is in a good condition.

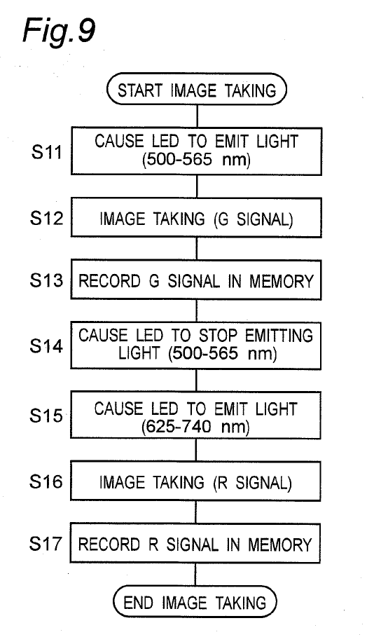

Next, referring to FIG. 1, FIG. 6, and FIG. 9, the image taking method for the object to be measured 21 is described more specifically. FIG. 9 is a flowchart of the image taking of the object to be measured in the intra-oral measurement system according to the first embodiment. It is noted that the image taking of the object to be measured 21 is carried out under the control of the image taking control unit 41, unless otherwise stated.

First, only the LED light source 24 that irradiates the light in the wavelength of 500 to 565 nm (green) is caused to emit light (Step S11).

Next, while irradiating the light in stripe pattern toward the object to be measured 21, the image of the object to be measured 21 is picked up (Step S12). Hereinafter, the image data piece of the object to be measured 21 picked up using the light in the wavelength of 500 to 565 nm is referred to as a G signal.

Subsequently, the G signal is recorded in the image recording unit 42 (Step S13).

Then, the LED light source 24 that irradiates the light in the wavelength of 500 to 565 nm is caused to stop emitting light (Step S14).

Thereafter, the LED light source 25 that irradiates the light in the wavelength of 625 to 740 nm (red) is caused to emit light (Step S15).

Next, while irradiating the light in stripe pattern toward the object to be measured 21, the image of the object to be measured 21 is picked up (Step S16). Hereinafter, the image data piece of the object to be measured 21 picked up using the light in the wavelength of 625 to 740 nm is referred to as an R signal.

Subsequently, the R signal is recorded in the image recording unit 42 (Step S17).

By carrying out Steps S11 to S17 described above, the image taking of the object to be measured 21 using the light in the different wavelengths is completed.

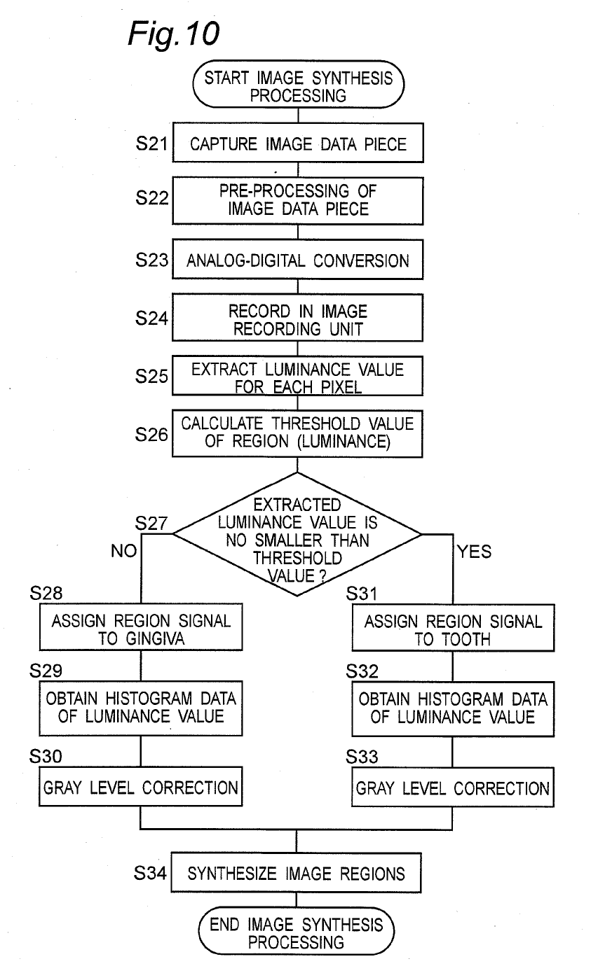

Next, referring to FIG. 1, FIG. 6, and FIG. 10, the image synthesis processing method is described. FIG. 10 is a flowchart of the image synthesis processing in the intra-oral measurement system according to the first embodiment. It is noted that the object to be measured 21 represents the tooth 22 and the gingiva 23 in the following description. Further, the image synthesis processing is carried out under the control of the two-dimensional image processing unit 43, unless otherwise stated.

First, the G signal and the R signal recorded in the image recording unit 42 are captured (Step S21).

Next, pre-processing such as noise removal is performed to the G signal and the R signal that have been captured (Step S22).

Subsequently, the G signal and the R signal that have been pre-processed are converted from analog signals into digital signals (Step S23).

Then, the G signal and the R signal that have been converted into the digital signals are recorded in the image recording unit 42 as a G signal image and an R signal image (Step S24).

Thereafter, a luminance value is extracted for each pixel, from the G signal image and the R signal image, as luminance information used to determine the regions for the tooth 22 and the gingiva 23 as the object to be measured 21 (Step S25). It is noted that, although the luminance values are taken as an example of the information used to determine the regions for the tooth 22 and the gingiva 23 in this description, a specific color signal can be used such as a color intensity or a color phase instead of the luminance values when a color CCD is used as the imaging sensor 18.

Subsequently, based on the luminance value for each pixel that has been extracted, a threshold value of the luminance values used in the determination of the regions for the tooth 22 and the gingiva 23 is calculated (Step S26). It is noted that the image used in the calculation of the threshold value at this time can be one of the G signal image and the R signal image. A method of setting the threshold value will be described later in detail.

Next, for each pixel in the G signal image and the R signal image, the luminance value of the pixel is compared with the calculated threshold value for the determination of the region, and the pixels whose luminance value is smaller than the threshold value are judged to be pixels that correspond to the region for the gingiva 23, and the pixels whose luminance value is not smaller than the threshold value are judged to be pixels that correspond to the region for the tooth 22. Based on the judgment results, the pixels in the G signal image and the R signal image are respectively divided into the pixel group corresponding to the region for the tooth 22 and the pixel group corresponding to the region for the gingiva 23 (Step S27).

Then, in Step S27, data of the pixel group that is judged to correspond to the region for the gingiva 23 is assigned with a region signal GA of the gingiva 23 (Step S28). Here, as the gingiva 23 is clearly shown in the R signal image, as described above, it is preferable to assign the region signal GA only to the pixel group of the R signal image that corresponds to the region for the gingiva 23.

Thereafter, histogram data of the luminance values of the pixel group corresponding to the region for the gingiva 23 is obtained (Step S29).

Next, the gray level correction is performed accordingly to the pixel group corresponding to the region for the gingiva 23 (Step S30). In the first embodiment, as will be described later, the histogram data of the luminance values of the pixel group corresponding to the region for the gingiva 23 concentrate on a low gray level region. Accordingly, it is preferable to perform such gray level correction that increases the luminance values of the pixel group corresponding to the region for the gingiva 23 (Step S30).

At the same time as Steps S28 to S30 or before or after these steps, in Step S27, data of the pixel group that is judged to correspond to the region for the tooth 22 is assigned with a region signal DA of the tooth 22 (Step S31). Here, as the tooth 22 is clearly shown in the G signal image, as described above, it is preferable to assign the region signal DA only to the pixel group of the G signal image that corresponds to the region for the tooth 22.

Thereafter, the histogram data of the luminance values of the pixel group corresponding to the region for the tooth 22 is obtained (Step S32).

Next, the gray level correction is performed accordingly to the pixel group corresponding to the region for the tooth 22. In the first embodiment, as will be described later, the histogram data of the luminance values of the pixel group corresponding to the region for the tooth 22 concentrate on a high gray level region. Accordingly, it is not necessarily required to perform such gray level correction that increases the luminance values of the pixel group corresponding to the region for the tooth 22.

Next, the data of the pixel group corresponding to the region for the gingiva 23 to which the region signal GA has been assigned and the data of the pixel group corresponding to the region for the tooth 22 to which the region signal DA has been assigned are synthesized (Step S34).

By carrying out Steps S21 to S34 described above, the image synthesis processing is completed.

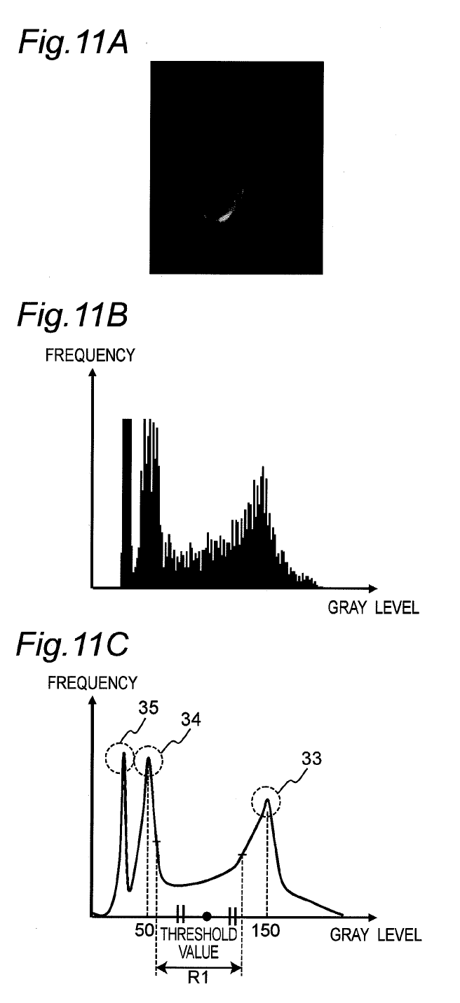

Next, referring to FIG. 11A to FIG. 11C, the method of setting the threshold value for determining the region using the G signal image is described. The G signal image includes an image of the tooth 22, the gingiva 23, and a surrounding region (here, a space).

FIG. 11A is a diagram showing the G signal image. FIG. 11B is the histogram of the luminance values in the G signal image of FIG. 11A. FIG. 11C is a graphical chart showing a smooth line connecting the histogram of FIG. 11B using a least-square technique. In FIG. 11B and FIG. 11C, a vertical axis indicates a frequency of the luminance values, and a horizontal axis indicates the gray level.

Referring to FIG. 11C, it can be seen that the histogram of the luminance values in the G signal image has three peak gray levels 33-35. In the G signal image, the luminance decreases in an order of the tooth 22, the gingiva 23, and the surrounding region due to a difference in the surface reflectivities. Accordingly, in the first embodiment, the peak gray level 33 is a peak gray level of the tooth 22, the peak gray level 34 is a peak gray level of the gingiva 23, and the peak gray level 35 is a peak gray level of the surrounding region.

As the purpose here is to set the threshold value of the region for the tooth 22 and the region for the gingiva 23, a middle point between the peak gray level 33 of the tooth 22 and the peak gray level 34 of the gingiva 23 is set as the threshold value, for example. For example, the luminance values are expressed in 256 gray levels using the LED light source 24 with an output of 3 W, the peak gray level 33 of the tooth 22 is 150 gray levels, and the peak gray level 34 of the gingiva 23 is 50 gray levels. In this case, the threshold value is 100 gray levels.

It is noted that, while the middle point between the peak gray level 33 and the peak gray level 34 is set as the threshold value in this description, the present invention is not limited to this example. For example, as shown in FIG. 11C, the threshold value can be set within a region R1 between the gray level that is half of the peak gray level 33 and the gray level that is half of the peak gray level 34.

As described above, as the intra-oral measurement system according to the first embodiment is provided with the LED light sources 24, 25 of the two different wavelengths, the clear images can be obtained for both of the region for the tooth 22 and the region for the gingiva 23. With this, it is possible to accurately measure the intra-oral shape. At this time, it is not necessary to spray the metal powder within the oral cavity.

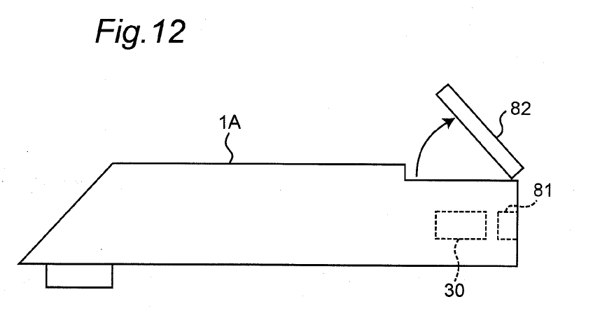

It is noted that, the present invention is not limited to the first embodiment, and can be implemented in various different modes. For example, while the first embodiment describes the intra-oral measurement system in which the image processing unit 40 is contained in the external device 20, the present invention is not limited to this example. For example, the image processing unit 40 can be configured to be mounted within the oral scanner 1A as shown in FIG. 12. In this case, as shown in FIG. 12, a data reading mechanism 81 for externally reading the data of the three-dimensional coordinates of the object to be measured 21 measured by the oral scanner 1A can be provided for the oral scanner 1A. The data reading mechanism 81 is, for example, a cable connector, a receiving-transmitting unit of a wireless communication (wireless LAN), or a slot of an SD memory card. Alternatively, as shown in FIG. 12, providing a small display unit 82 that can change its angel for the oral scanner 1A eliminates the necessity of the connection of the oral scanner 1A to the external device 20 having the display unit 50, thereby further improving convenience.

### Second Embodiment

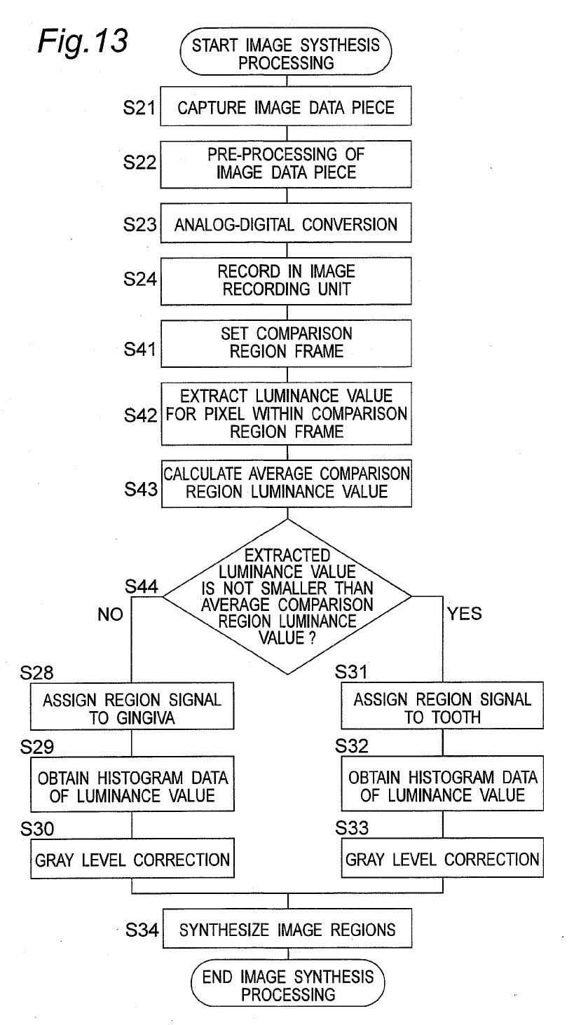

FIG. 13 is a flowchart of the image synthesis processing in the intra-oral measurement system according to a second embodiment of the present invention. The intra-oral measurement system according to the second embodiment is different from the intra-oral measurement system according to the first embodiment in that, in the flow of the image synthesis processing, Steps S41 to S44 are carried out instead of Steps S25 to S27 shown in FIG. 10. In FIG. 13, Steps S21 to S24, and S28 to S34 are the same as the steps in the first embodiment described referring to FIG. 10, and therefore, a redundant explanation is not repeated and only Steps S41 to S44 will be described.

In Step S41, comparison region frames are set in the G signal image and the R signal image. The comparison region frames are set so as to include a boundary between the tooth 22 and the gingiva 23, and such that an area of the tooth 22 and an area of the gingiva 23 are identical. Further, the comparison region frames are set at a position corresponding both in the G signal image and the R signal image.

In Step S42, the luminance value of each pixel located within the comparison region frames of the G signal image and the R signal image is extracted.

In Step S43, an average value of the extracted luminance values of the pixels within the comparison region frames (hereinafter referred to as an average comparison region luminance value) is calculated. Note that, at this time, the image used for the calculation of the average comparison region luminance value one of the G signal image and the R signal image. In the second embodiment, the average comparison region luminance value is set as the threshold value.

In Step S44, for each pixel within the comparison region frames, the luminance value of the pixel is compared with the calculated average comparison region luminance value, and the pixels whose luminance value is smaller than the average comparison region luminance value are judged to be pixels that correspond to the region for the gingiva 23, and the pixels whose luminance value is no smaller than average comparison region luminance value are judged to be pixels that correspond to the region for the tooth 22. Based on the judgment results, the pixels in the comparison region frame of the G signal image and the pixels in the comparison region frame of the R signal image are respectively divided into the pixel group corresponding to the region for the tooth 22 and into the pixel group corresponding to the region for the gingiva 23.

The intra-oral measurement system according to the second embodiment, the region for the tooth 22 and the region for the gingiva 23 are divided only in vicinity of the boundary between the tooth 22 and the gingiva 23. Specifically, as it is apparent that which image, the G signal image or in the R signal image, clearly shows the object in a region that is not in vicinity of the boundary, it is judged which region the pixel corresponds to, the region for the tooth 22 or the region for the gingiva 23, for a part of the pixels in the G signal image and the R signal image. With this, it is possible to reduce the time taken for the image synthesis processing.

### Third Embodiment

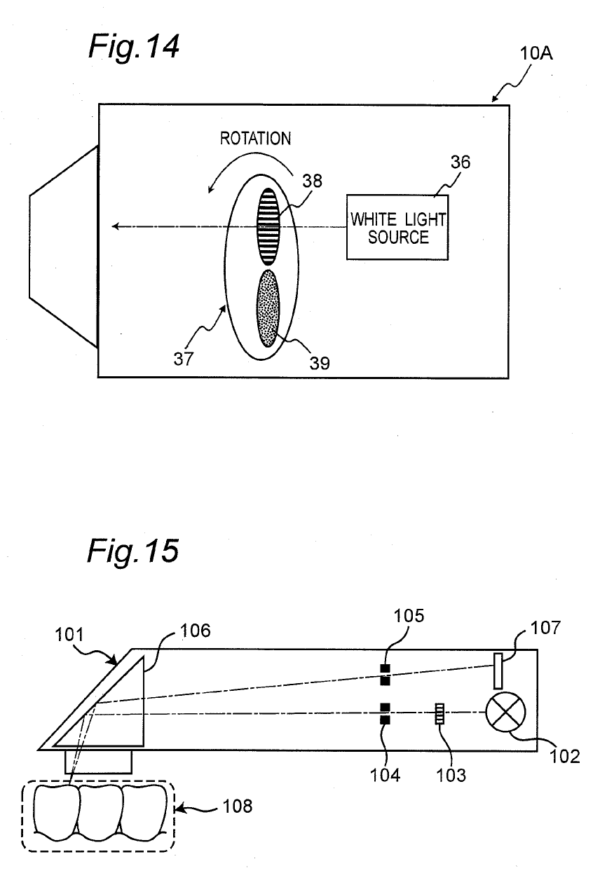

FIG. 14 is an illustrative view showing a schematic configuration of the light projecting unit of the intra-oral measurement system according to a third embodiment of the present invention. The intra-oral measurement system according to the third embodiment is different from the intra-oral measurement system according to the first embodiment in that a light projecting unit 10A is provided instead of the light projecting unit 10. As the third embodiment is the same as the first embodiment other than the light projecting unit 10A, a redundant explanation is not repeated and only a difference will be described.

Referring to FIG. 14, the light projecting unit 10A is provided with a single white light source 36, and an R (red) wavelength filter 38 and a G (green) wavelength filter 39 that is movable on a light axis of the white light source 36. The R wavelength filter 38 is to convert light irradiated from the white light source 36 into the light in the wavelength of 500 to 565 nm, and the G wavelength filter 39 is to convert light irradiated from the white light source 36 into the light in the wavelength of 625 to 740 nm. The R wavelength filter 38 and the G wavelength filter 39 are disposed on a rotary disk 37, and is configured to be movable on the light axis of the white light source 36 by the rotation of the rotary disk 37.

According to the intra-oral measurement system of the third embodiment, as the light projecting unit 10A is configured as described above, a number of the light source can be one. With this, the light projecting unit 10A can be designed to be comparatively small. Further, it is possible to quickly switch the wavelengths of the light irradiated from the light projecting unit 10A.

It is noted that, while the rotary disk 37 is provided with the two wavelength filters 38, 39 in the above description, the present invention is not limited to such an example and three or more wavelength filters can be provided.

Although the measurement method by distinguishing the tooth (enamel and dentin) 22 from the gingiva 23 is described in the embodiments of the present invention, the present invention is not limited to such an example. By setting the surface reflectivity and the gray level of the luminance accordingly, in addition to the tooth 22 and the gingiva 23, it is possible to carry out the measurement by distinguishing a resin base denture (plastic denture) from a metal base denture. With this, it is possible for the patient to learn the current condition of an artificial tooth.

Further, by setting the surface reflectivity and the gray level of the luminance accordingly, it is possible to distinguish a dental plaque from a dental calculus. In this case, it is considered to be possible to realize tartar control at home by regularly checking a presence of the dental plaque or the dental calculus.

By properly combining arbitrary embodiments of the aforementioned various embodiments, the effects owned by each of them can be made effectual.

The intra-oral measurement device and the intra-oral measurement system according to the present invention is able to correctly measure a shape of an intra-oral object to be measured such as a tooth and a gingiva having different surface reflectivities of light, and thus can be used in an application of directly measuring fitness of a dental prosthesis having a different reflectivity of light within an oral cavity.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The entire disclosure of Japanese Patent Application No. 2008-125537 filed on May, 13, 2008, including specification, claims, drawings, and summary are incorporated herein by reference in its entirety.

1-8. (canceled)

9. An intra-oral measurement device comprising:
a light projecting unit for irradiating lights in at least two different wavelengths including a first wavelength and a second wavelength along an identical light axis toward an object to be measured that includes at least a tooth in an oral cavity;
a image pickup unit for receiving lights reflected from the object to be measured and picking up an image; and
an image processing unit for extracting an image of enamelum of the tooth from an image of a reflected light in the first wavelength received by the image pickup unit, extracting an image of dentin and a gingiva of the tooth from an image of a reflected light in the second wavelength received by the image pickup unit, and synthesizing the extracted image of the enamelum with the extracted image of the dentin and the gingiva, thereby obtaining an image of the tooth.

10. The intra-oral measurement device according to claim 9, further comprising: a gap retaining member for retaining a gap between the tooth and the light projecting unit and a gap between the tooth and the image pickup unit constant.

11. The intra-oral measurement device according to claim 10, wherein the gap retaining member has a dual structure in which a tip end that is brought into contact with the tooth is soft, and a main body that is fixed to the device has a predetermined degree of hardness.

12. The intra-oral measurement device according to claim 9, wherein the light projecting unit irradiates lights in a coded stripe pattern.

13. The intra-oral measurement device according to claim 9, wherein the first wavelength is 500 to 565 nm and the second wavelength is 625 to 740 nm.

14. The intra-oral measurement device according to claim 9, wherein the image processing unit synthesizes a plurality of images based on the lights in the different wavelengths picked up by the image pickup unit into a single image, and converts the synthesized image into three-dimensional coordinates, thereby obtaining a three-dimensional image of the object to be measured.

15. The intra-oral measurement device according to claim 14, wherein the image processing unit synthesizes the plurality of images based on the lights in the different wavelengths according to luminance information of each pixel in the images.

16. An intra-oral measurement method, comprising:
irradiating lights in at least two different wavelengths including a first wavelength and a second wavelength along an identical light axis toward an object to be measured that includes at least a tooth in an oral cavity;
receiving lights reflected on the object to be measured; and
extracting an image of enamelum of the tooth from an image of the reflected light in the first wavelength that has been received, extracting an image of dentin and a gingiva of the tooth from an image of the reflected light in the second wavelength that has been received, and synthesizing the extracted image of the enamelum with the extracted image of the dentin and the gingiva, thereby obtaining an image of the tooth.
